(19) United States
(12) Patent Application Publication
(10) Pub. No.: US 2004/0247419 A1
(43) Pub. Date: Dec. 9, 2004

(54) Trailer deck elevator and tractor/trailer transportation method

(76) Inventor: Mark Aaron Hill, Williams Lake (CA)

Correspondence Address: BARRIGAR INTELLECTUAL PROPERTY GROUP, 290 - 1675 DOUGLAS STREET, VICTORIA, BC, V8W 2G5, CA

(21) Appl. No.: 10/453,537

(22) Filed: Jun. 4, 2003

(51) Int. Cl. B60P 3/07

(52) U.S. Cl. 414/480

(57) ABSTRACT

A flatbed lead trailer is conventional except that it includes a articulating deck elevator mechanism for supporting and reversibly elevating the front end of the trailer. The articulating deck elevator mechanism is longitudinally symmetrical about its longitudinal center axis and includes spaced longitudinally extending hoisting arms each pivotally coupled at a proximal end to the deck, and a pair of spaced extensible members each preferably a hydraulic ram pivotally coupled at its upper end to the deck and at its lower end to the hoisting arm. The distal ends of the hoisting arms are provided with bushings or bearings in which a distal roller is rotatably mounted. The hydraulic rams are operable to pivot the hoisting arms between a lowered position and a raised position. In the lowered position, the front end of the trailer contacts the ground, permitting a tractor to drive onto the trailer for transport of the tractor atop the trailer or its pup.

### FIELD OF THE INVENTION

This invention relates to a trailer deck elevator for lifting (and lowering) the deck of a trailer of a tractor-trailer rig so as to permit the front end of the trailer to move from the ground into alignment with the fifth wheel of the tractor, and vice versa, thereby to permit the trailer when in elevated position to be readily detached from or coupled to the tractor, and when the front end thereof is in contact with the ground, to permit the trailer to receive a vehicle or the like onto its deck.

In another aspect, the invention relates to a method of loading and unloading one tractor/trailer rig, with or without a pup trailer, onto the trailer(s) of another tractor-trailer rig, thereby permitting the latter to transport both tractor/trailer rigs as a single combined unit.

### BACKGROUND OF THE INVENTION

Tractor-trailers are used for transporting loads from one location to a second location. The load is off-loaded at the second location and frequently, the tractor-trailer is returned empty to the first location. Although it is well known that returning a tractor-trailer empty is inefficient, it has proven difficult to co-ordinate loads from the second location back to the first location. Accordingly, alternate approaches have been developed in attempts to overcome this problem.

One alternative that is frequently employed in the use of rail cars in conjunction with tractor-trailers. A rail car carries the trailer to the tractor and the tractor then delivers the trailer with its load to the second location, returning the empty trailer to the rail car for delivery back to the first location. This approach can improve the efficiency of long-haul transportation.

Another alternative that has been employed for tractors and flat decks is to “piggy-back” them, having one vehicle partly carry and partly tow the other. This alternative typically involves loading the back of the tractor or flat deck onto the deck of the carrying/towing vehicle. A saddle on the carrying/towing vehicle supports and retains the back of the vehicle to be towed, while the front of the vehicle to be towed remains on the road. A number of vehicles can be “piggy-backed” and towed by the towing vehicle using this approach. However, the towed vehicle continues be subjected to wear and tear on some of its wheels, tires and bearings. Towing from the front of the vehicle does not improve the situation, unless it is a front-wheel-drive vehicle, and in fact may result in further wear, as the drive shaft continues to turn.

In addition to the above shortcomings of piggy-back towing, it is not very suitable for transporting tractor-trailer units. This is because the trailer articulates from the tractor in tractor-trailer rigs. Therefore, the part of the towed rig on the road may have a tendency to track differently from the tracking of the towing vehicle.

Another approach that has been employed to transport vehicles, including tractor-trailers, is to load one directly onto the deck of the other. This frequently requires the use of special equipment in order to load the second vehicle. An approach to addressing the need for special equipment was disclosed in U.S. Pat. No. 3,841,509. A tractor-trailer rig designed to carry one rig on top of the other for return-trip transport was disclosed that includes a lifting apparatus. The lifting apparatus is comprised of a retractable lifting frame having rollers that engage channels mounted on the undercarriage of the trailer. The lifting frame retracts by pivoting as the rollers are moved along the channel. Movement along the track may be hydraulically controlled. The lifting apparatus is located near the front of the trailer and facilitates lowering and raising the front of trailer to and from the ground.

In addition to the lifting apparatus disclosed in the aforementioned patent, further modifications of the tractor-trailer rig are required to allow loading and unloading of the tractor-trailer rig with a second tractor-trailer rig. These features include an inclined sliding track mounted to the underside of the trailer frame that allows the trailer bogies to be moved from the rear of the trailer towards the front of the trailer and a sliding track on the rear frame of the tractor chassis that allows the trailer hitch to be moved from the back of the tractor towards the front. The inclusion of the sliding bogies and hitch described above appear to prevent the use of such a design on a tractor-trailer of conventional design and construction. Hence, a custom built unit may be required in order to function according to the disclosure in the aforementioned patent. Even without appreciable custom building, implementation of the design approach reflected in the patent would be cumbersome and expensive.

### SUMMARY OF THE INVENTION

It is an objective of the present invention to provide a method of transporting two flatbed tractor/trailer rigs, with or without pup trailers, as an integrated unit, without any piggy-backing. Depending upon trailer dimensions, it may be necessary that the carrying rig include both a lead trailer and a pup trailer.

To this end, the present invention involves making use of a relatively simple and inexpensive deck lifting or elevating device mounted on the undercarriage of the carrying trailer (or the lead trailer if the carrying rig includes a pup trailer also) forward of the support wheels of the carrying trailer. When the carrying trailer is detached from the tractor hauling it, the articulating deck elevator mechanism is able to raise and lower the forward portion of the trailer deck, thereby permitting the carrying trailer to pivot about the foremost of its support wheels. When the articulating deck elevator mechanism is retracted against the undercarriage, the trailer deck front end is in contact with the ground, permitting the other rig to be driven onto it. When the articulating deck elevator mechanism is extended to give support to the deck, the trailer deck can be maintained in generally horizontal alignment to permit the front end of the trailer to be coupled with the tractor fifth wheel.

In a preferred embodiment of one aspect of the invention, an articulating deck elevator mechanism of the aforementioned type is provided having a truss-like transverse frame preferably having transversely spaced hoisting arms that are each pivotally attached to the deck undercarriage of the trailer. The hoisting arms may be reversibly pivoted from a retracted position against the undercarriage, in which position the articulating deck elevator mechanism occupies little or no vertical space (when the deck is horizontally oriented), to an extended position in which the distal ends of the hoisting arms extend downwardly sufficiently that they support the trailer and maintain the deck in generally horizontal alignment or with a slightly raised front end so that the hitch can be coupled to (or detached from) the fifth wheel of a tractor. Because the trailer may move longitudinally during the hitching or unhitching or during the loading of another rig onto it, the distal end of the transverse frame is preferably provided with a set of wheels or one or more rollers that in the extended position make contact with the ground, thereby to facilitate such longitudinal motion of the trailer without destabilizing the trailer or the articulating deck elevator mechanism. The extension and retraction of the articulating deck elevator mechanism is preferably effected by a transversely spaced pair of conventional hydraulic rams suitably pivotally connected between the deck undercarriage and the frame of the articulating deck elevator mechanism.

In another aspect of the invention, a trailer fitted with the aforementioned articulating deck elevator mechanism may be characterized as a “kneeling trailer”, since it is capable of “kneeling” to permit the front end of its deck to contact the ground, in which position another tractor/trailer rig may be driven onto the kneeling trailer. For reasons to be discussed in detail below, if the rigs to be transported each include a pup trailer, it may be helpful if both leading trailers are equipped with an articulating deck elevator mechanism according to the invention, to facilitate the loading of both pup trailers. Note that while trailer dimensions are variable, in most cases it will be necessary that the carrying rig include both a lead trailer and a pup trailer, in order to accommodate the length of the carried tractor and its lead trailer. If the carried rig also has a pup trailer, that pup trailer can be carried atop the lead trailer of the carried rig.

In one another aspect of the invention, the articulating deck elevator mechanism is provided with at least one and preferably with a spaced pair of safety bars to provide support and stability for the articulating deck elevator mechanism frame, especially in the event of a hydraulic failure that reduces the hydraulic pressure in the rams. Each such safety bar may be pivotally mounted on the undercarriage of the trailer deck and may swing downward to engage the lowered articulating deck elevator mechanism frame near its distal end so as to be able to bear the trailer deck and its load in the event of hydraulic failure or the like. When not in use, the safety bar may be retained in place under the deck and generally parallel to the deck.

When there are two or more trailers (a lead trailer and a pup) in the rig, it is preferable to have a bridge plate that is preferably hinged to the back end of the deck, which when in the bridging position, provides a surface that extends between the trailer decks.

In another aspect of the invention, a method is provided for loading at least one tractor-trailer rig onto another tractor-trailer rig, the lead trailer of the latter being of the flatbed type, and towing a flatbed pup. The method works optimally if both rigs are of the flatbed type, but some latitude is permitted for the carried rig. If the tractor-trailer to be carried has both a lead trailer and a pup, the pup is first loaded onto the to-be-carried lead trailer using conventional means, such as a fork lift, or else, if the to-be-carried lead trailer is a flatbed trailer provided with an articulating deck elevator mechanism according to the invention, by using a tractor to back the to-be-carried pup trailer onto the to-be-carried lead trailer when the latter is “kneeling” to receive the pup. Thereafter the to-be-carried tractor-trailer rig is loaded onto the kneeling carrying trailer and its pup, preferably by driving the to-be-carried tractor onto the lead carrying trailer and thence to the carrying pup, leaving the to-be-carried lead trailer atop the carrying lead trailer. When the to-be-carried rig has been loaded and preferably has been stabilized to the extent that the carrying lead trailer may be elevated to its normal horizontal position, the articulating deck elevator mechanism is extended to elevate and support the carrying lead trailer. (Note that depending upon the weight distribution and the location of the support wheels for the carrying lead trailer, the act of driving the to-be-carried tractor-trailer rig onto the carrying lead trailer may conceivably shift the balance sufficiently that the carrying lead trailer without the assistance of the articulating deck elevator mechanism may resume a horizontal orientation. However, the articulating deck elevator mechanism should nevertheless be extended both to stabilize the carrying lead trailer while it is being coupled to its hauling tractor, and possibly to elevate the trailer front end above horizontal alignment to facilitate coupling of the trailer front end to the fifth wheel of the tractor.) The to-be-carried rig may be further attached to the carrying trailers by means of safety cables, chains, etc. as may be required.

In another aspect of the invention, a kit is provided to retrofit lead trailers of a rig to enable loading and carrying another rig, as described above. The kit is comprised of the essential elements of the articulating deck elevator mechanism and suitable fittings for attaching the articulating deck elevator mechanism to the undercarriage of a trailer. The kit may additionally include optional components, such as one or two safety bars and fittings, and any hydraulic components not already present on the trailer to be equipped with the articulating deck elevator mechanism.

An articulating deck elevator mechanism in accordance with the invention is relatively simple, for the most part making use of standard shelf components or components that are easily manufactured. The overall cost of manufacture and attachment to a trailer is relatively low. The articulating deck elevator mechanism is simple and easy to use, is effective for its intended purpose, and minimizes road wear and tear on the tractor/trailer rigs making use of it.

### SUMMARY OF THE DRAWINGS

FIG. 1. A schematic side elevation view of a tractor-trailer rig equipped with an articulating deck elevator mechanism according to the invention.

FIG. 2A. A schematic side elevation view of the pup of FIG. 1 detached from the lead trailer in preparation for loading onto the lead trailer.

FIG. 2B. A schematic side elevation view of the lead trailer and tractor of FIG. 1 with the lead trailer detached from the tractor and supported in part by the articulating deck elevator mechanism.

FIG. 3. A schematic side elevation view of the tractor-trailer rig of FIG. 1 showing the tractor loading the pup onto the lead trailer.

FIG. 4. A schematic side elevation view of the tractor-trailer rig of FIG. 1 showing the pup loaded onto the lead trailer.

FIG. 5. A schematic side elevation view of the tractor-trailer rig of FIG. 1 showing the lead trailer in the raised position, partly supported by the articulating deck elevator mechanism, in preparation for attaching to the tractor.

FIG. 6. A schematic side elevation view of the tractor-trailer rig of FIG. 1 being driven onto a second lead trailer and its pup, the second lead trailer also being equipped with an articulating deck elevator mechanism according to the invention and having its front end in contact with the ground to receive the first rig.

FIG. 7. A schematic side elevation view of the tractor-trailer rigs of FIG. 6 showing the upper rig loaded onto the lower lead trailer and its pup.

FIG. 8. A schematic side elevation view of the tractor-trailer rigs of FIG. 6 with the upper rig loaded and the lower rig hitched.

FIG. 9. An end elevation view partially in section of a portion of the lead trailer of FIG. 1 taken along line 9-9 of FIG. 1, showing the mounting of the hoisting arms of a preferred embodiment of the articulating deck elevator mechanism according to the invention.

FIG. 10. A schematic side elevation view of a preferred embodiment of the articulating deck elevator mechanism of FIG. 1 attached to the support frame for the deck and shown in the lowered position.

FIG. 11. A schematic side elevation view of the articulating deck elevator mechanism of FIG. 10 attached to the support frame for the deck and shown in the collapsed position.

FIG. 12. A schematic isometric view of the articulating deck elevator mechanism of FIG. 10 and associated portions of the lead trailer of FIG. 1.

### DESCRIPTION OF THE PREFERRED EMBODIMENT

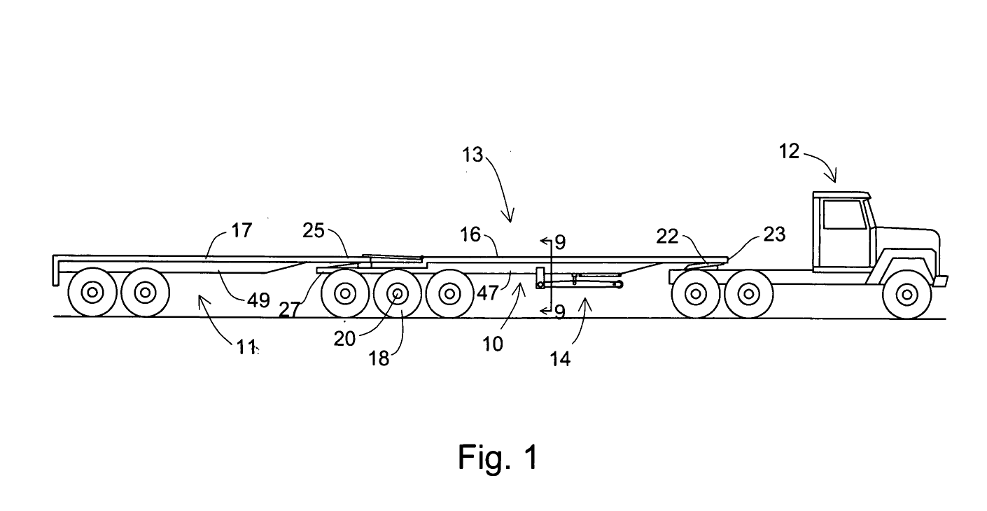

Referring to FIG. 1, a flatbed tractor/trailer combination (rig) 13 comprising tractor 12, lead or main trailer 10, and pup trailer 11 is conventional but for the trailer articulating deck elevator mechanism 14 to be described further in detail. The trailers 10, 11 have conventional undercarriages including, as support for the decks 16, 17 thereof respectively, spaced longitudinal beams 47 (for trailer 10) and 49 (for trailer 11). These beams are I beams. The undercarriages are in turn supported by conventional axles 20 on which trailer support wheels 18 are rotatably mounted. The front end 23 of the lead trailer 10 engages the tractor fifth wheel 22 in a conventional pivotable hitching engagement, and the front end 25 of the pup trailer 11 is provided with an essentially similar hitch for pivotally engaging an essentially similar fifth wheel 27 at the tail of the lead trailer 10. It is apparent that either the lead trailer 10 or the pup trailer 11 could be hitched to the tractor 12, but for maximum load, the two trailers 10, 11 are used in the hitching sequence illustrated in FIG. 1.

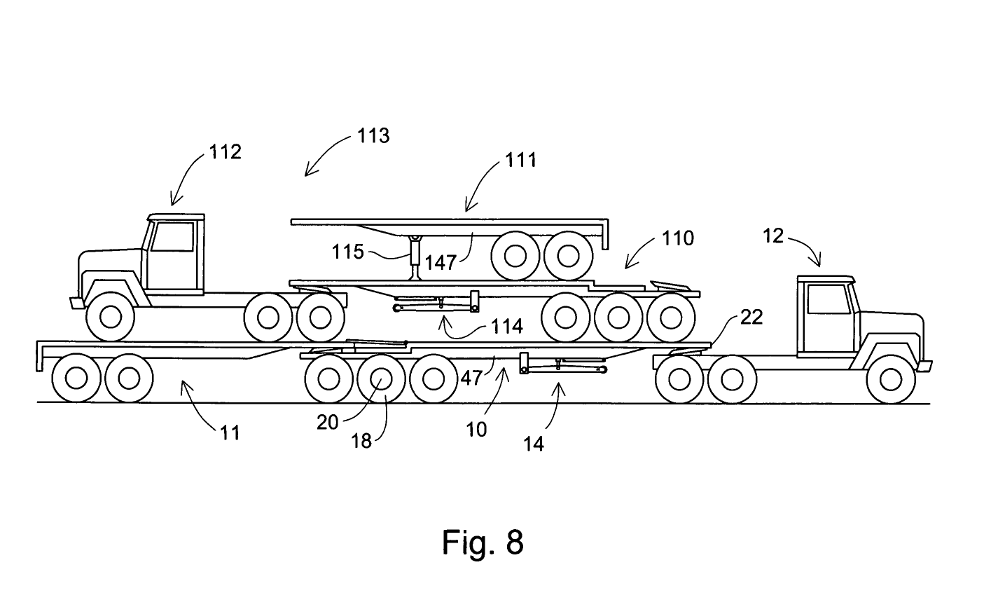

A second tractor/trailer rig 113 essentially identical to the tractor/trailer rig 13 comprises tractor 112, lead trailer 110 and pup trailer 111, and may be transported on the trailers 10 and 11, as illustrated in FIG. 8. The articulating deck elevator mechanism 14 (on trailer 10) and 114 (on trailer 110) facilitate the mounting of tractor/trailer rig 113 for transportation on trailers 10, 11, as will be described below. Of course it is completely arbitrary which of the two tractor/trailer rigs 13, 113 serves as the carrier for the other. If the two rigs differed somewhat in length, it would be expected in many cases that the longer of the two would serve as the carrier, for ease of mounting the other.

In FIGS. 1 and 8, the trailers 10, 11 are shown in normal horizontal orientation for transportation and load carrying. However, in that orientation, it is difficult to load and mount the rig 113 (say) on the rig 13. Accordingly, according to the invention, to facilitate the loading of the rig 113 on trailers 10 and 11 (or vice versa), each of the lead trailers 10, 110 is provided with an articulated deck elevator generally indicated as 14 (for the trailer 10) and 114 (for the trailer 110). The two articulating deck elevator mechanisms 14, 114 are essentially identical.

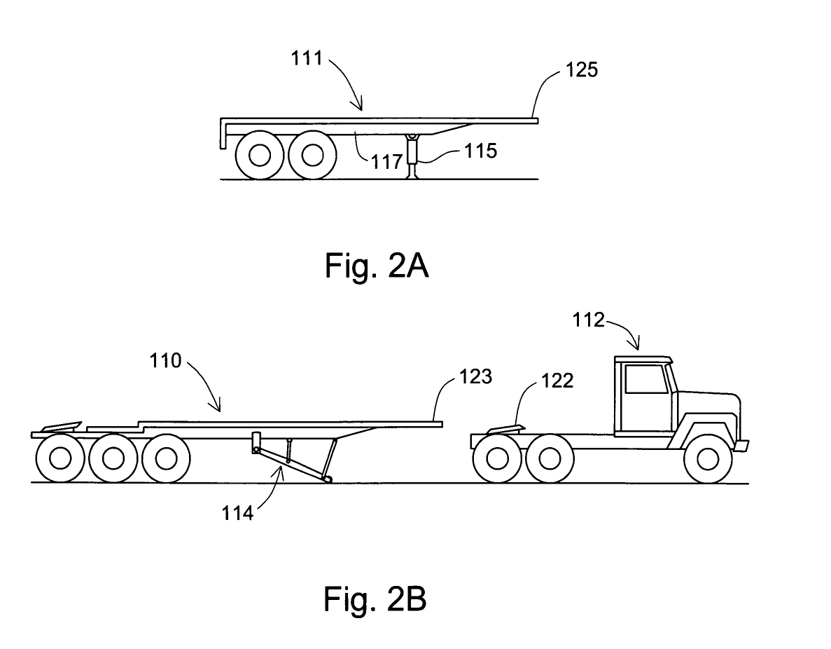

Each articulating deck elevator mechanism 14, 114 has a collapsed position (as seen in FIGS. 1 and 8, for example) and an extended position, viz a trailer deck supporting position (as seen in FIGS. 2B and 5). The articulating deck elevator mechanisms 14, 114 are able to retract upwardly from their extended positions to fully retracted collapsed positions in close proximity to the underside of the decks 16, 116 respectively into spaces or wells aside or between longitudinal undercarriage beams 47, 147 of the undercarriages/deck supports respectively of trailers 10, 110 to which they are respectively attached.

The sequence of mounting steps required to place the rig 113 on the trailers 10, 11 of the rig 13 (i.e., to reach the configuration of FIG. 8) is illustrated in FIGS. 2A to 7 inclusive.

Step 1 (FIG. 2A): The pup trailer 111 is detached from the lead trailer 110. The pup trailer 111 is maintained in horizontal orientation by means of a pair of conventional hydraulic jacks 115 attached to the underside of the pup trailer deck 117 at opposite sides thereof.

Step 2 (FIG. 2B): The lead trailer 110 is detached from the tractor 112. The lead trailer 110 is maintained in horizontal orientation by means of the articulating deck elevator mechanism 114 shown in extended deck supporting position in FIG. 2B.

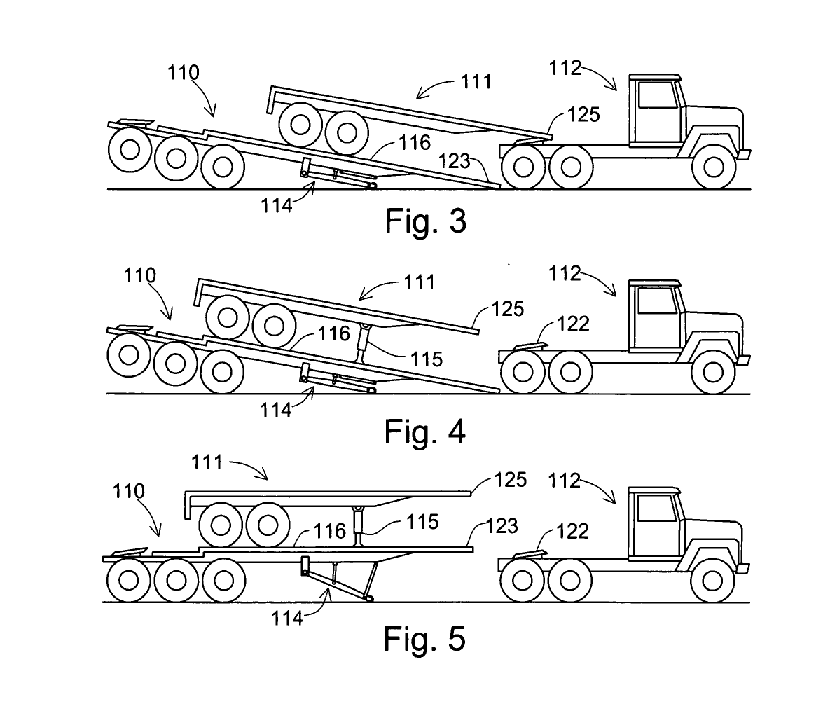

Step 3 (FIG. 3): The articulating deck elevator mechanism 114 is retracted, permitting the front end 123 of the lead trailer 110 to engage the ground. The pup trailer 111 is hitched at its front end 125 to the fifth wheel 122 of the tractor 112 and backed onto the “kneeling” inclined deck 116 of the lead trailer 110. Alternatively, a fork-lift vehicle or a crane can be used to load the pup trailer 111 onto the lead trailer 110. Note that if a tractor is used to back the pup 111 onto the lead trailer 110, there will be a fairly pronounced angle of articulation in the vertical plane between the tractor 112 and the pup 111. Depending upon the dimensions and configuration, the angle of articulation may be too severe to permit step 3 to be accomplished by using the “kneeling” loading technique, and some other suitable means of loading the pup 111 onto the lead trailer 110 may be necessary.

Step 4 (FIG. 4): The pup trailer 111 is detached from the tractor 112. It is convenient before detaching the tractor 112 to anchor the pup trailer 111 to the lead trailer 110 by suitable cables, chains, etc. and to maintain its front end 125 in elevated position relative to the deck 116 of the lead trailer 110 by extending the foot of conventional jacks 115 downward so that the front end 125 can clear the fifth wheel 122 of the tractor 112.

Step 5 (FIG. 5): The articulating deck elevator mechanism 114 is extended into deck elevating mode for elevating the deck 116 of the trailer 110 into approximately a horizontal position, and preferably high enough that the front end 123 of the lead trailer 110 can clear the fifth wheel 122 comfortably to permit the tractor 112 to be coupled to the lead trailer 110.

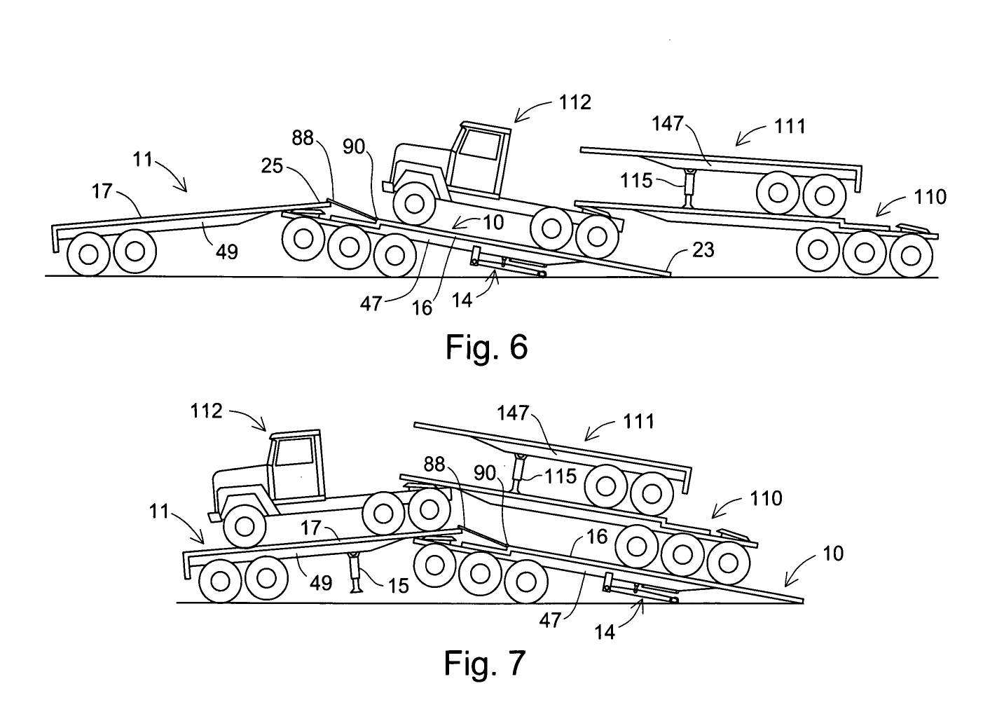

Step 6 (FIG. 6): The tractor 12 is detached from the lead trailer 10. The articulating deck elevator mechanism 14 is retracted, permitting the front end 23 of the trailer 10 to contact the ground. The tractor 112 then drives onto the deck 16 of the trailer 10, pulling the lead trailer 110 with it, and the pup trailer 111 atop the lead trailer 110.

Step 7 (FIG. 7): The tractor 12 continues its progress toward the tail of the pup trailer 11, passing over a bridge plate 88 that bridges the gap between the rear end 90 terminating the deck 16 of the lead trailer 10 and the front end 25 of the pup trailer 11. Although FIG. 7 continues to show the rear wheels 18 of the lead trailer 10 off the ground, at some point the weight of the tractor 112 will probably force the wheels 18 of the lead trailer 10 into contact with the ground (depending upon the geometry and the relative weight of the tractor 112 and the trailers 110, 111). If not, the articulating deck elevator mechanism 14 can be moved into extended position so that the lead trailer 10 is forced into an approximate horizontal orientation. If there is a risk of shock from a sudden tilting of the deck 16 as the tractor 112 moves toward the tail of the pup trailer 11, the jack 15 can be overextended and then slowly retracted as the decks 16, 17 of the trailers 10, 11 respectively tilt into generally horizontal orientation.

Step 8 (FIG. 8): All trailers are in horizontal orientation and the tractor 12 is coupled to the trailer 10 for hauling both rigs to a return destination. Preferably the deck 17 of the pup trailer 11 has shallow cavities for receiving the steering wheels of the tractor 112, to help stabilize the tractor 112 while it is being carried.

For unloading the rig 113 from the rig 13, the foregoing steps are more or less reversed. Care should be taken to ensure that the brakes are applied to both carrying tractor and the carrying trailer.

The articulating deck elevator mechanism 14, essentially identical to the articulating deck elevator mechanism 114, will now be described in detail.

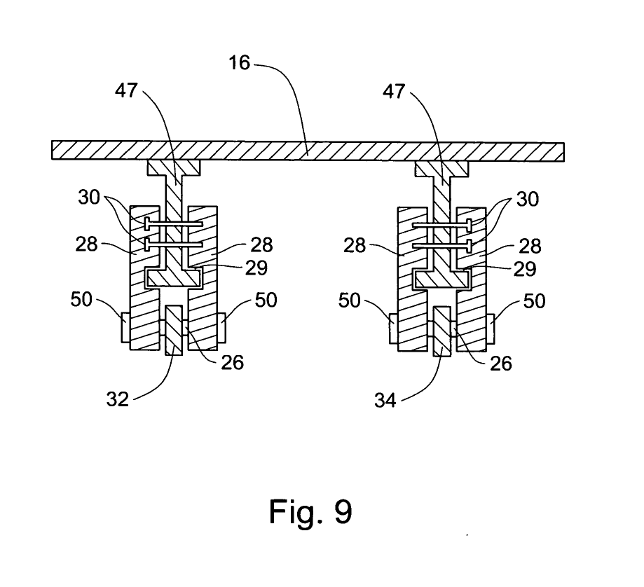

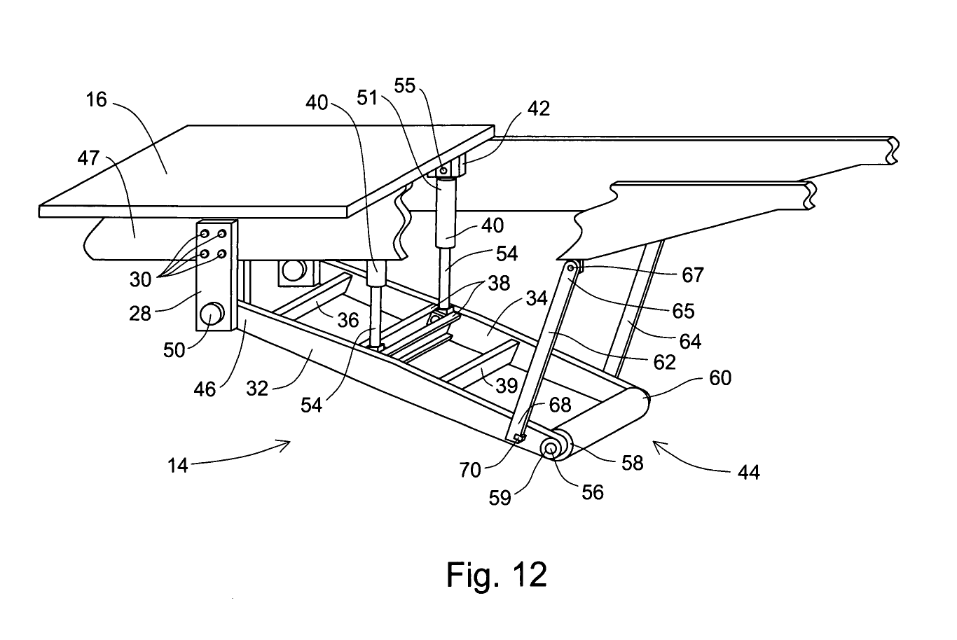

As shown in FIGS. 9 and 12, each of the mating spaced pivotable hoisting arms 32, 34 of the articulating deck elevator mechanism 14 is mounted at its proximal end on a spaced pair of bracket stubs 28, that together comprise a mounting bracket. The bracket stubs 28 are vertically oriented and downwardly depending from longitudinal undercarriage I beams 47 that support the deck 16 of lead trailer 10. One pair of bracket stubs 28 is located underneath and on one side of the deck 16, and the pair of bracket stubs 28 is located underneath and on the other side of the deck 16. Each bracket stub 28 is made of two plates each, welded together to form a slot 29 to accept the horizontal portion of the undercarriage beam 47. The bracket stubs 28 are bolted to the web of the I beam and to each other with 12 bolts 30. The proximal ends of the hoisting arms 32, 34 are pivotally mounted on axles 26, respectively mounted for rotation in bushings 48 (FIG. 12). The axial movement of the axles 26 is constrained by stops 50 that keep the axles 26 in place. The spacing of the hoisting arms 32, 34 is maintained by transverse spacing and stabilizing members 36, 39 welded at their ends to the hoisting arms 32, 34; these cross pieces 36, 39 add structural rigidity and strength to the articulating deck elevator mechanism 14. The articulating deck elevator mechanism 14 is symmetrical about its longitudinal centre axis and the hoisting arms 32, 34 are approximately parallel to one another. The space between the hoisting arms 32, 34 is selected to be wide enough to provide stability to the trailer 10 while still permitting the articulating deck elevator mechanism 14 to retract.

At the distal ends of the hoisting arms 32, 34, which in the preferred embodiment are forward facing, is rotatably mounted a roller mechanism 44. The roller mechanism 44 is comprised of a shaft 56, oppositely disposed roller flange bearings 58 on each end of the shaft 56, a centering ring 59, and a peripheral roller cylinder 60 surrounding the shaft 56. The roller 60 is rotatably mounted on the shaft 56 by means of the roller flange bearings 58 mounted in suitable holes in the distal ends of the hoisting arms 32, 34. When the articulating deck elevator mechanism 14 is supporting the deck 16 above the ground, the roller 60 permits longitudinal movement of the trailer 10 as needed. The length of the roller 60 is selected to provide stability to the trailer 10 while permitting retraction of the articulating deck elevator mechanism 10.

Intermediate the support and stabilizing members 36, 39 are transversely mounted two channel members 38 whose ends are welded to the hoisting arms 32, 34. The channel members 38 are spaced from one another by approximately 8 inches to provide a slot sufficiently wide enough to accept piston shoes 53 and to permit pivotal movement of hydraulic rams 40.

The piston shoes 53 are securely mounted between the channel members 38, one at each end of the channel members 38, and the distal ends of the piston arms 54 are pivotally mounted on the piston shoes by means of axles 55. The axial movement of the axles 55 is constrained by cotter pins 57 that keep the axles 55 in place.

The upper ends 51 of the hydraulic rams 40 are similarly pivotally mounted on piston shoes 53 by means of axles 55. Again, the axial movement of the axles 55 is constrained by cotter pins 57 that keep the axles 55 in place. The piston shoes 53 are welded between two transversely mounted plates 42 that extend vertically downward from the underside of the deck 16 and are welded to the undercarriage beams 47. These plates are of 1¼ inch thick T1 steel and are 5 inches deep. They are spaced apart by approximately 8 inches to permit sufficient pivotal movement of the hydraulic rams 40.

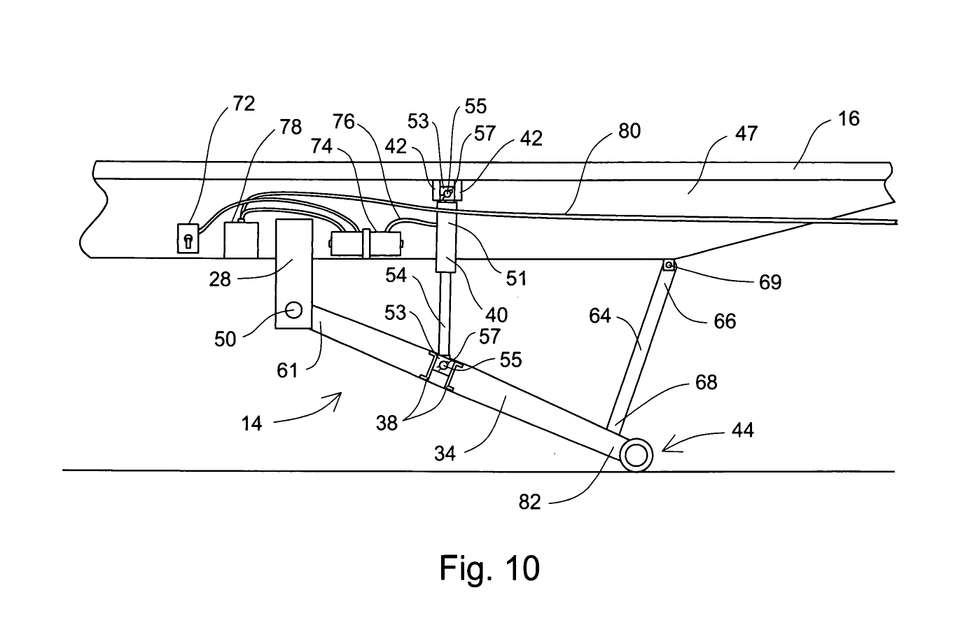

In the illustrated preferred embodiment, the rams 40 are actuated by a solenoid 72 or other suitable switching means and movement is then controlled by a hydraulic reservoir/pump 74 that is in fluid communication with the rams by means of hydraulic lines 76 (FIG. 10). Electricity is provided by a battery 78, which can be recharged by the alternator in the tractor-trailer rig by attaching a power line 80 from the tractor 12 to the battery 78. This ram structure and operation and the requisite pressurized hydraulic fluid supply and control are entirely conventional.

All elements of the articulating deck elevator mechanism 14 should be made of steel of suitable strength and toughness, for example, T1 steel, to be able to elevate the deck 16 under expected load, with due allowance for some overload. For additional strength, elements such as the support and stabilizing members 36, 39 may be made of sections of I-beam extrusions.

Preferably, the longitudinal position of the articulating deck elevator mechanism 14 on the trailer 10 is selected to optimize the lifting capacity of the mechanism and to minimize the tendency of the trailer 10 to pivot about the articulating deck elevator mechanism 14. The articulating deck elevator mechanism 14 should collapse sufficiently in fully retracted position so that the articulating deck elevator mechanism 14 does not interfere with the ability of the front end 23 of the trailer 10 to make contact with the ground, and this requirement also may influence the choice of longitudinal position of the articulating deck elevator mechanism 14 on the trailer 10. The foregoing considerations, coupled with the need to design the hydraulic rams 40 and associated hydraulics to be able to lift the deck 16 under load without too long a stroke, also influence the choice of dimensions of the constituent elements of the articulating deck elevator mechanism 14 and the positioning of the piston shoes 53 for the hydraulic rams 40. In the preferred embodiment, the hydraulic rams 40 have a stroke of approximately 10 to 12 inches. The hydraulic rams 40, and hence the plates 42 and channel members 38 are positioned on the hoisting arms to provide a 1:3 ratio of piston stroke to vertical movement of the hoisting arms 32, 34.

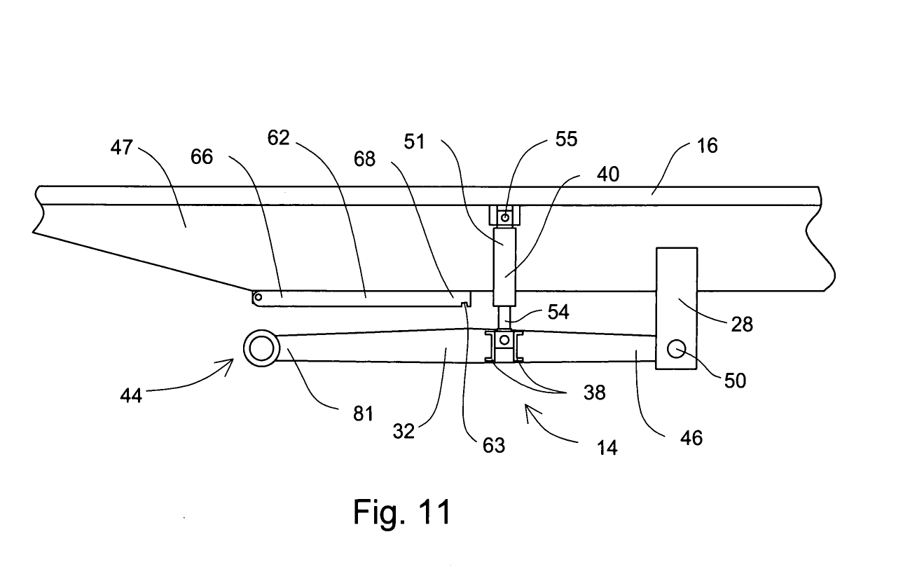

In the preferred embodiment illustrated, the articulating mechanism 14 is provided with two safety bars 62, 64. Each safety bar 62, 64 is pivotally mounted at its upper proximal end 65, 66 respectively on pins 67, 69 respectively welded to the undercarriage beams 47 of the trailer 10. In use, when the piston arms 54 are fully extended, a notch 63 (FIG. 11) at the proximal end 68 of safety bar 62 engages a catch 70 (FIG. 12) welded near the distal end of hoisting arm 32 such that the safety bar 62 extends between the undercarriage beam 47 and the hoisting arm 32. The design of this notch/catch arrangement permits ready engagement and disengagement of the notch 63 with the catch 70. When the notch 63 is in engagement with the catch 70, the safety bar 62 is able to accept a compressive load applied between the hoisting arm 32 and the beam 47 to which the upper portion of the safety bar 62 is mounted, thereby providing additional support for the trailer 10 when the safety bar 62 engages the catch 70. The safety bar 64 engages an essentially similar catch on hoisting arm 34 and functions in essentially the same way as the safety bar 62. When not in use, the safety bars 62 64 are swung into rest positions adjacent and generally parallel to the undercarriage beams 47, and are preferably maintained in rest position by suitable catches or hooks or the like (not illustrated). The safety bars 62, 64 are comprised of a suitably selected material, for example, T1 steel, that is sufficiently strong enough to support the applied compressive load if, for example, the hydraulics were to fail when the articulating deck elevator mechanism 14 is supporting the deck 16 loaded with a rig comprising a pup 111, lead trailer 110 and tractor 112.

The articulating deck elevator mechanism 14 can be operated by a single operator. Prior to detaching the trailer 10 from the tractor 12, the distal ends 81, 82 of the hoisting arms 32, 34 respectively are lowered by actuating the hydraulic pump 74, thereby extending the piston arms 54. Once in a lowered position, the distally mounted roller mechanism 44 provides support for the deck 16. If the ground is soft or rough, it is best to provide a surface such as a 2×12 on which to rest the roller 60. The load is borne by the rams 40 and their associated pistons and fittings, but the load can be partially borne and stabilized by swinging the safety bars 62, 64 downwardly from their rest positions parallel to the beams 47 and into engagement with the hoisting arms 32, 34. Once the articulating deck elevator mechanism 14 is supporting the deck 16, the trailer 10 can be readily detached from or coupled to the tractor 12.

Note that the invention may be implemented not only as original equipment on a trailer, but also by means of a kit for retrofitting a trailer. The kit is comprised of the articulating deck elevator mechanism 14, and fittings to be welded or otherwise attached to the trailer 10. The kit could comprise, for example, two axles 26 to be suitably mounted proximal to the deck 16, two hoisting arms 32, 34, two hydraulic rams 40, and a roller mechanism 44 for mounting at the distal ends of the hoisting arms 32, 34. The kit would optionally comprise at least one and preferably two safety bars 62, 64 and associated catches. If the trailers were not provided with a bridge plate 88, that plate and associated hinges and other fittings could also be provided. If the trailer 10 were not already provided with hydraulics for other purposes (such as to raise or lower an optional set of wheels, depending upon trailer load), then a switching mechanism 72, a hydraulic reservoir/pump 74, hydraulic lines 76 and a battery 78 could also form part of the kit.

Other variants and options will readily occur to those familiar with tractor/trailer rig design. For example, the tractor/trailer rig described herein may well be any vehicle-type that can be rotated about a central axis to raise and lower an end. Further, the load need not be restricted to a second tractor/trailer rig. The scope of the invention is not limited to the specific embodiments illustrated and described above, but is as set forth in the appended claims.

What is claimed is:

1-20 (cancelled)

21. A method for hauling a tractor/trailer/pup rig as a load on a hauling tractor/trailer/pup trailer rig, each trailer having a front hitch for hitching to a respective tractor and a rear hitch for hitching to a respective pup, the method comprising the steps of:
a) loading the load pup on the load trailer;
b) loading the load tractor and load trailer on the hauling trailer and hauling pup, wherein, when loaded, the load tractor and load trailer are hitched one to the other, the hauling trailer and hauling pup are hitched one to the other, and the wheels of the load tractor are on the hauling pup and the wheels of the load trailer are on the hauling trailer; and
c) once the load pup is loaded on the load trailer and the load tractor and load trailer are loaded on the hauling trailer and hauling pup, pulling the load trailer, load pup, load tractor, load trailer and load pup with the hauling tractor.

22. The method of claim 21, further comprising the step of positioning the load tractor and load trailer on the hauling trailer and hauling pup wherein the hitch between the load tractor and load trailer is substantially vertically aligned with the hitch between the hauling trailer and the hauling pup.

23. The method of claim 21, wherein the step of loading the load pup on the load trailer occurs prior to the step of loading the load tractor and load trailer on the hauling trailer and hauling pup.

24. The method of claim 23, wherein the step of loading the load pup on the load trailer comprises the steps of:
a) unhitching the load pup from the load trailer;
b) hitching the load pup to the load tractor or hauling tractor,
c) backing the load pup onto the load trailer using the tractor hitched to the load pup; and
d) unhitching the tractor from the load pup.

25. The method of claim 24, further comprising the steps of:
a) lowering the front end of the load trailer prior to backing the load pup onto the load trailer; and
b) raising the front end of the load trailer after unhitching the tractor from the load pup.

26. The method of claim 25, wherein:
a) the step of lowering the front end of the load trailer comprises retracting a trailer elevator mechanism attached to the underside of the load trailer between the load-trailer front hitch and the load-trailer wheels; and
b) the step of raising the front end of the load trailer comprises extending the elevator mechanism.

27. The method of claim 21, wherein the step of loading the load tractor and load trailer on the hauling trailer and hauling pup, comprises:
a) lowering the front end of the hauling trailer; and
b) driving the load tractor and load trailer onto the hauling pup and hauling trailer via the lowered front end of the hauling trailer.

28. The method of claim 27, further comprising the step of placing bridging between the hauling trailer and hauling pup for driving the load trailer on when passing from the hauling trailer to the hauling pup.

29. The method of claim 27, wherein the step of lowering the front end of the hauling trailer comprises retracting a trailer elevator mechanism attached to the underside of the hauling trailer between the hauling-trailer front hitch and the hauling-trailer wheels.

30. The method of claim 27, further comprising the step of raising the front end of the hauling trailer after the step of driving the load tractor and load trailer onto the hauling pup and hauling trailer.

31. The method of claim 29, wherein the step of raising the front end of the hauling trailer comprises extending a trailer elevator mechanism attached to the underside of the hauling trailer between the hauling-trailer front hitch and the hauling-trailer wheels.

32. A method for hauling a tractor/trailer/pup rig as a load on a hauling tractor/trailer/pup trailer rig, each trailer having a front hitch for hitching to a respective tractor and a rear hitch for hitching to a respective pup, the method comprising the steps of:
a) first, loading the load pup on the load trailer, by:
I) unhitching the load pup from the load trailer;
ii) hitching the load pup to the load tractor or hauling tractor;
iii) lowering the front end of the load trailer;
iv) backing the load pup onto the load trailer using the tractor hitched to the load pup; and
v) unhitching the tractor from the load pup;
vi) raising the front end of the load trailer
b) loading the load tractor and load trailer on the hauling trailer and hauling pup, by:
i) lowering the front end of the hauling trailer;
ii) placing bridging between the hauling trailer and hauling pup;
iii) driving the load tractor and load trailer onto the hauling pup and hauling trailer via the lowered front end of the hauling trailer and the bridging: and
iv) raising the front end of the hauling trailer;
wherein, when loaded, the load tractor and load trailer are hitched one to the other, the hauling trailer and hauling pup are hitched one to the other, the wheels of the load tractor are on the hauling pup and the wheels of the load trailer are on the hauling trailer; and the hitch between the load tractor and load trailer is substantially vertically aligned with the hitch between the hauling trailer and the hauling pup; and
c) once the load pup is loaded on the load trailer and the load tractor and load trailer are loaded on the hauling trailer and hauling pup, pulling the load trailer, load pup, load tractor, load trailer and load pup with the hauling tractor.

33. The method of claim 32, wherein:
a) the step of lowering the front end of the load trailer comprises retracting a trailer elevator mechanism attached to the underside of the load trailer between the load-trailer front hitch and the load-trailer wheels; and
b) the step of raising the front end of the load trailer comprises extending the elevator mechanism.

34. The method of claim 32, wherein:
a) the step of lowering the front end of the hauling trailer comprises retracting a trailer elevator mechanism attached to the underside of the hauling trailer between the hauling-trailer front hitch and the hauling-trailer wheels; and
b) the step of raising the front end of the hauling trailer comprises extending the trailer elevator mechanism.

35. The method of claim 32, wherein:
a) the step of lowering the front end of the load trailer comprises retracting a pair of hydraulic rams, each ram having one end attached to the underside of the load trailer and the other end attached to a hoisting arm, each hoisting arm having a proximal end pivotally attached to the underside of the load trailer and a distal end suitable for partially supporting the load trailer, wherein retracting the rams causes the hoisting arms to pivot relative to the load trailer so as to reduce the distance between the distal ends of the hoisting arms and the underside of the load trailer; and
b) the step of raising the front end of the load trailer comprises extending the hydraulic rams so as to increase the distance between the distal ends of the hoisting arms and the underside of the load trailer.

36. The method of claim 32, wherein:
a) the step of lowering the front end of the hauling trailer comprises retracting a pair of hydraulic rams, each ram having one end attached to the underside of the hauling trailer and the other end attached to a hoisting arm, each hoisting arm having a proximal end pivotally attached to the underside of the hauling trailer and a distal end suitable for partially supporting the hauling trailer, wherein retracting the rams causes the hoisting arms to pivot relative to the hauling trailer so as to reduce the distance between the distal ends of the hoisting arms and the underside of the hauling trailer; and
b) the step of raising the front end of the hauling trailer comprises extending the hydraulic rams so as to increase the distance between the distal ends of the hoisting arms and the underside of the hauling trailer.
